(19) United States
(12) Patent Application Publication
(10) Pub. No.: US 2009/0183143 A1
(43) Pub. Date: Jul. 16, 2009

(54) METHOD AND APPARATUS FOR GENERATING TEST CASES OF SOFTWARE SYSTEM

(76) Inventors: Zhong Jie Li, Beijing (CN); He Hui Liu, Beijing (CN); Naomi Mitsumori, San Jose, CA (US); Hua Fang Tan, Beijing (CN); Jun Zhu, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/350,280

(22) Filed: Jan. 8, 2009

(30) Foreign Application Priority Data
Jan. 10, 2008 (CN) 200810002615.2

(51) Int. Cl. G06F 9/44

(52) U.S. Cl. 717/126; 717/128

(57) ABSTRACT

A method and an apparatus for generating test cases of a software system. The method includes the steps of: tracing a user request to acquire IT events related to each service and/or component invocation; forming IT transactions based on correlation information in IT events; correlating said IT transactions based on predetermined correlation rules, in order to form a business transaction; and extracting from the business transaction a business transaction pattern corresponding to said business transaction. The method further includes generating test cases of a software system based on the generated business transaction pattern. The apparatus includes hardware for accomplishing the foregoing method steps.

### CROSS-REFERENCE TO RELATED APPLICATIONS

This application claims priority under 35 U.S.C. §119 from Chinese Patent Application No. 200810002615.2 filed Jan. 10, 2008, the entire contents of which are incorporated herein by reference.

### BACKGROUND OF THE INVENTION

1. Field of the Invention

The present invention generally relates to the field of data processing and, in particular, to a method and an apparatus for generating a business pattern and business level test cases by using runtime trace.

2. Description of the Related Art

Software testing has long been recognized as a key and challenging step in system development activities. The appearance of Service-Oriented Architectures (SOA) proposes new requirements on software testing. SOA, a coarse-granularity and loosely coupled service architecture, can deploy, combine and use loosely coupled and coarse-granularity application components in a distributed way through a network on demands. In SOAs, services communicate through simply and precisely defined interfaces without involving low level programming interfaces or communication models.

Compared with traditional software programming environments, SOA-based software testing mainly boasts the following features: 1) software systems are intrinsically distributed, and this requires that Quality of Service (QoS) be ensured for different development configurations; 2) systems implement adaptive behaviors, either by replacing individual services or adding new ones.

In traditional software testing, a combination of unit testing, integrated testing, system testing, and regression testing is needed to gain confidence that a system will deliver the expected functionality. Although many consolidated testing approaches, applied over traditional systems, apply over service-oriented systems as well, the dynamic and adaptive nature of SOA makes most testing techniques not directly applicable to test services and service-oriented systems. For example, most traditional testing approaches assume that a developer is always able to precisely identify the actual piece of code that is invoked at a given call-site, or, as in the case of object-oriented programming languages, that a developer knows all the possible (finite) bindings of a polymorphic component. These assumptions are not applicable to SOAs, which exhibit real-time discovery and late binding of services in an open marketplace environment.

The adoption of SOA, in addition to changing the architecture of a system, brings changes in the process of building the system. The SOA system is not built at one time but needs many rounds of iteration to achieve satisfactory quality. Each round of iteration includes three steps: building one version, testing the version, and deploying the tested version to a production environment.

The dynamic and adaptive nature of SOA systems makes it difficult for developers to foresee all its usage profiles. Therefore, it is difficult for testers to design test cases that can cover all the usage scenarios at the first round of iteration. However, usage scenarios coverage is very important to make sure that the expected quality at user level is achieved. Therefore, to supplement a test set with uncovered real usage scenarios is the key to making SOA systems achieve the expected quality level. The test cases which present real usage scenarios but do not exist in the current test set should be added in the next round of iteration. Therefore, determining how to find the uncovered real usage scenarios and supplement them to the set of test cases becomes a focal point of the research on software testing technologies for SOAs.

A possible solution is to leverage runtime trace information to find uncovered usage scenarios and then generate test cases for them to supplement the test set. However, there are the following challenges: 1) how to form meaningful usage scenarios from runtime trace information; 2) how to control the number of test cases. From the angle of testers, the usage scenario should be a meaningful sequence of interactions between users and a system. Therefore, there is a need for a method to correlate interactions between users and a system. Meanwhile, since it is impossible for testers to cover all the real happening situations, there is another need to control the number of test cases while covering usage scenarios.

As is clear from the above analysis, there is a need for some mechanism to define the coverage criteria and reduce the number of test cases in software testing for SOA systems.

For example, AmberPoint provides an SOA runtime governance solution. It captures the web service messages across diverse environments to create realistic “dry runs” in the staging, creates actual responses to verify functionality, provides ideal load-testing and capacity-planning scenarios that mimic actual distribution, and simulates production services outside the immediate control of the project or the department. However, AmberPoint does not care about the business usage scenario at the application level. All of its focus is on the web service itself.

In addition, Tivoli ITCAM by IBM provides a runtime monitoring function. It traces the service/component interaction for one user request. Such a set of service/component interactions for a user request is called an IT transaction. However, Tivoli ITCAM does not provide the ability to form a business transaction in order to form the functionality of business transactions which is meaningful for business level testers.

There are no methods in the prior art to generate a business transaction pattern by using runtime trace or solutions to generate test cases by using runtime trace.

### SUMMARY OF THE INVENTION

It is an object of the present invention to generate business transaction patterns through runtime trace for usage scenarios.

It is another object of the present invention to generate business level test cases through runtime trace for usage scenarios so as to cover at a maximum all usage scenarios in the next round of iteration.

According to an aspect of the present invention, there is provided a method for generating test cases of a software system, including the steps of: tracing a user request to acquire IT events related to a service and/or component invocation; forming IT transactions based on correlation information in the IT events; correlating the IT transactions based on predetermined correlation rules in order to form a business transaction; and extracting from the business transaction a business transaction pattern corresponding to the business transaction.

According to another aspect of the present invention, the method of the present invention further includes generating test cases of a software system based on the acquired business transaction pattern.

According to a further aspect of the present invention, there is provided an apparatus for generating test cases of a software system. The apparatus includes: means for tracing a user request to acquire IT events related to each service and/or component invocation; means for forming IT transactions based on correlation information in IT events; means for correlating the IT transactions based on predetermined correlation rules in order to form a business transaction; and means for extracting from the business transaction a business transaction pattern corresponding to the business transaction.

According to a still further aspect of the present invention, the apparatus of the present invention further includes means for generating test cases of a software system based on the acquired business transaction pattern.

### BRIEF DESCRIPTION OF THE DRAWINGS

The features, advantages, and other aspects of the present invention will become more apparent from the following detailed description when taken in conjunction with the accompanying drawings in which:

FIG. 1 illustrates a high-level conceptual view of a method for generating business level test cases according to an embodiment of the present invention;

FIG. 2 illustrates a schematic view for generating IT transactions and business transactions according to an embodiment of the present invention;

FIG. 3 illustrates a schematic view for generating business transaction patterns according to an embodiment of the present invention;

FIG. 4 illustrates an instance of generating business transactions and business transaction patterns according to the present invention;

FIG. 5 illustrates a high-level block diagram of an apparatus for generating business level test cases according to an embodiment of the present invention;

FIG. 6 illustrates a flowchart of a method for generating business level test cases according to an embodiment of the present invention;

FIG. 7 illustrates a high-level conceptual view of a method for generating business level test cases according to another embodiment of the present invention;

FIG. 8 illustrates a high-level block diagram of an apparatus for generating business level test cases according to another embodiment of the present invention; and

FIG. 9 illustrates a flowchart of a method for generating business level test cases according to another embodiment of the present invention.

It is to be understood that like reference numerals denote the same parts throughout the figures.

### DETAILED DESCRIPTION OF PREFERRED EMBODIMENTS

For the purpose of clarity, to the following terms used in the present invention are hereby defined.

IT Event: record on a computer operation, which records the context of the operation and includes the invoked services, operation, parameter values and other correlation information.

IT Transaction: set of a series of IT events of a system caused by user interactions with a machine, which starts when the user clicks a button on a browser interface or other user interfaces to send a request and which ends when data requested by the user are displayed on the browser interface or other user interface.

Business Transaction: combination of a set of IT transactions to fulfill a meaningful business activity (such as goods ordering, shopping, an airline ticket reservation, etc).

Business Transaction Pattern: model of business transactions with common features extracted from business transactions.

A detailed description will be given below to each embodiment according to the present invention with reference to the accompanying drawings.

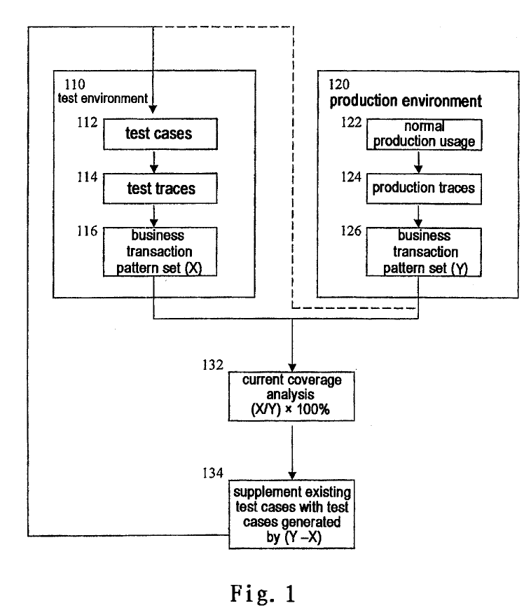

Referring to FIG. 1, there illustrates a high-level conceptual view of a method for generating business level test cases according to an embodiment of the present invention.

The method shown in FIG. 1 comprises two trace processes, one of which focuses on a production stage, and the other of which focuses on a testing stage. This method extracts a business transaction pattern set from each trace process respectively. Then, the two business transaction pattern sets are compared to find an uncovered business transaction pattern set. Finally, the related test cases are generated and supplemented to the set of current test cases for the uncovered business transaction patterns so as to be used in the next round of testing.

Specifically, as shown in FIG. 1, a test environment 110 is a test environment in which testers test a software system, and a production environment 120 is an environment in which users actually use the software system.

Before the start of the first round of testing, testers first generate test cases used for the first round of testing by a traditional method. In production environment 120, a production environment-based business transaction pattern set 126, which is represented here by symbol “Y,” is formed through normal production usage 122 and production traces 124 of a software system under testing. In test environment 110, test traces 114 are implemented for test cases 112 to form a test environment-based business transaction pattern set 116, which is represented here by symbol “X.”

Then, in a block 132, coverage analysis is implemented for the current round of testing through comparing test environment-based business transaction pattern set (X) 116 with production environment-based business transaction pattern set (Y) 126. That is, (X/Y)×100% is computed.

Afterwards, in a block 134, current test cases are supplemented by using the uncovered business transaction patterns (Y−X) set which is derived from the comparison between business transaction pattern set (Y) 126 and business transaction pattern set (X) 116. Next, the next round of regression testing is executed.

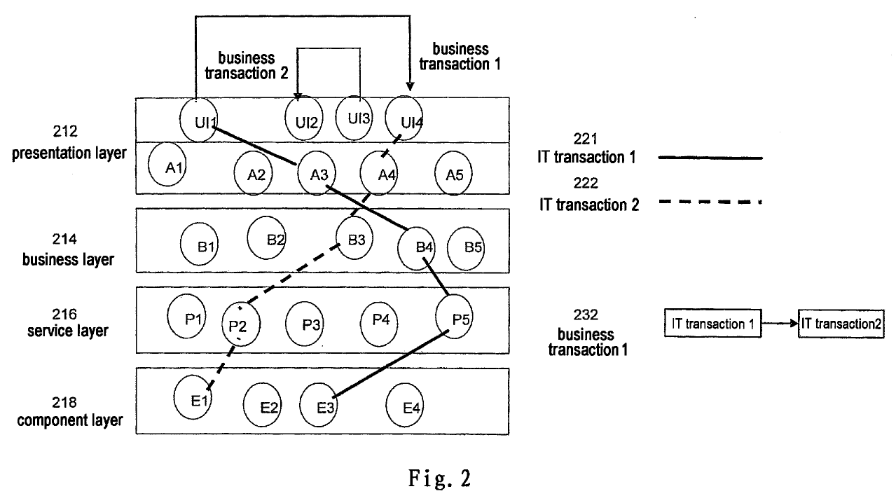

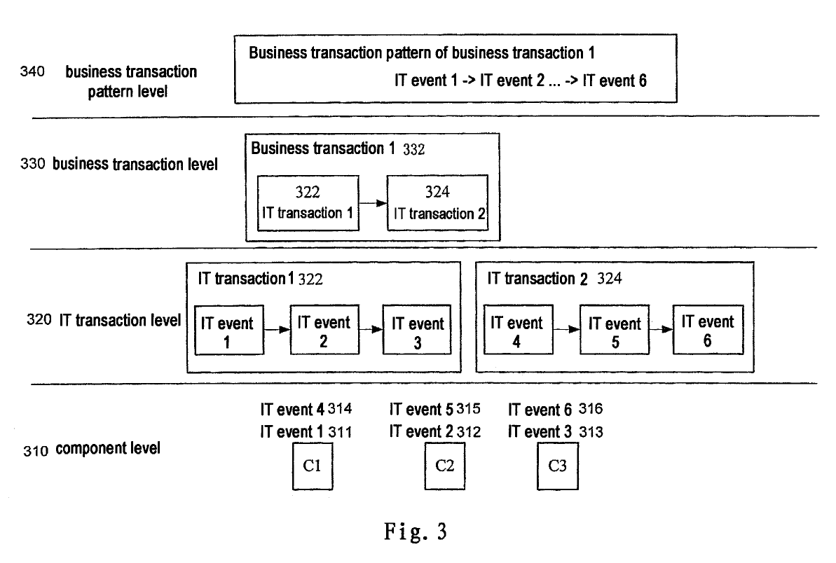

A detailed description will be given below to a method for generating a business transaction pattern according to the present invention with reference to FIG. 2 and FIG. 3.

FIG. 2 illustrates a schematic view for generating IT transactions and business transactions according to an embodiment of the present invention. Usually, in the process of generating business transactions there are involved a presentation layer 212, a business layer 214, a service layer 216, and a component layer 218. As shown by solid lines in FIG. 2, at presentation layer 212, resources A3 are called through user interactions UI 1, and resources B4 at business layer 214, resources P5 at service layer 216, and resources E3 at component layer 218 are involved in this process. This series of resources are correlated to form an IT transaction 1 221. Likewise, as shown by dotted lines in FIG. 2, resources A4 are called through user interactions UI 4, and resources B3 at business layer 214, resources P2 at service layer 216, and resources E1 at component layer 218 are involved in this process. This series of resources are correlated to form an IT transaction 2 222. IT transaction 1 221 and IT transaction 2 222 may be correlated according to set correlation rules, such as with the same BPID (Business Process Instance ID). In this manner, IT transaction 1 221 and IT transaction 2 222 are correlated to form a business transaction 1 232.

FIG. 3 illustrates a schematic view for generating business transaction patterns according to an embodiment of the present invention. As shown in FIG. 3, the generation of business transaction patterns is illustrated at a component level 310, IT transaction level 320 and business transaction level 330 respectively.

Component level 310 comprises three components, namely C1, C2 and C3, which generate IT event 1 322 to IT event 6 316 respectively. At IT transaction level 320, IT events 1-3 are found through tracing user requests. As is clear from the foregoing definition, an IT transaction is a set of a series of IT events of a system caused by user interactions with a machine, that is, a series of IT events. It starts with sending a request on a browser by a user and ends with displaying data requested by the user on the browser page. Each IT event contains its current correlation factor, and if it has a preamble IT event, then it contains the correlation factor of the preamble event which is called father correlation factor. According to the paternity between correlation factors, a set of IT events may be correlated to form an IT transaction. In this manner, IT events 1-3 form an IT transaction 1 322 and IT events 4-6 form an IT transaction 2 324. During the formation of each IT transaction, attribute values in its corresponding IT events, which are related to the correlation rule, will be extracted to form feature values of the IT transaction. According to correlation rules and feature values corresponding to each IT transaction, a set of IT transactions may be correlated to form a business transaction.

As shown in business transaction level 330, IT transaction 1 322 and IT transaction 2 324 are correlated according to the correlation rules (such as process instance ID or task instance ID), to form a business transaction 1 332.

As shown in business transaction pattern level 340, all IT events in business transaction 1 are extracted to form a business transaction pattern of business transaction 1.

It is to be understood that there is a fairly large number of IT events in operation records. If test cases are generated by combining IT events at random, then the number of test cases will be too large and many test cases are actually meaningless. Through extracting business transaction patterns in the aforesaid manner, then a combination of IT events with business meaning may be found. Thus, this method is able to search a combination of IT events which may be used for generating test cases with business meaning and especially for generating scenarios which were not tested but used in practical applications.

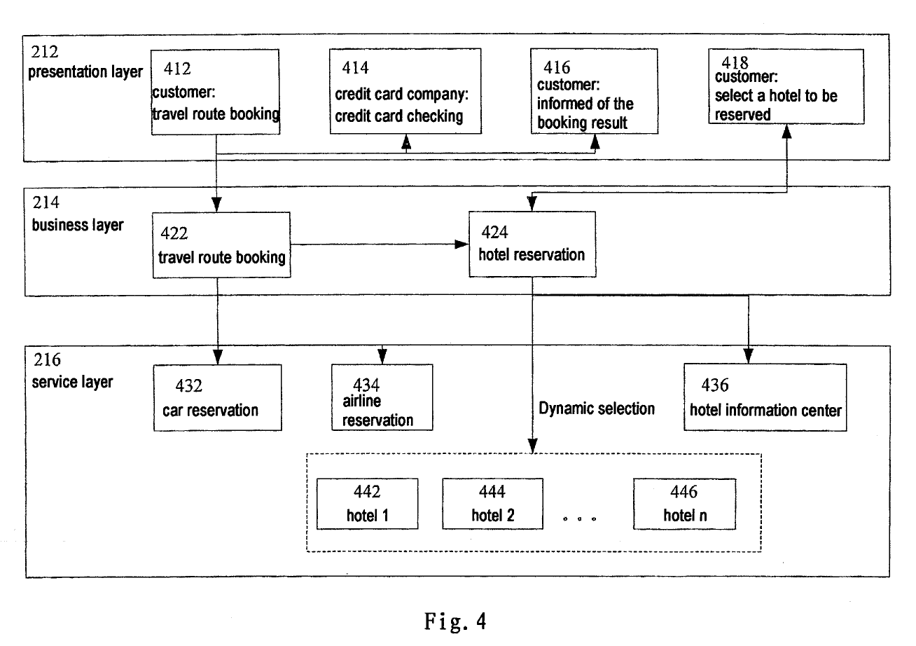

A detailed illustration will be given to how to form business transaction patterns with reference to FIG. 4.

First, trace code is added to a middleware layer to monitor occurring IT events. That is, monitoring code is added to the implementation flow of a system under testing and at code which is creating and has completed tasks. Then, according to the preset correlation rules (here, assume the current correlation rules are that correlations are implemented according to TASK ID (Task ID) and BPID (Business Process Instance ID)) and the definition on business transaction, the occurrence of the following IT events are recorded:

1) the calling of each component, wherein the component is, for example, a JSP, Business Process, Web Service, EJB or SCA component;

2) the initiation and end of each process; and

3) the creation, implementation and completion of each task.

Each IT events contains the context of the current event, i.e. the correlation factor (called father correlation factor) of the last IT event and the correlation factor of the current IT event. The occurring correlation factor of the current thread is saved in the context of the thread. When the request is across threads, the current correlation factor is delivered through a request message.

After all IT events are recorded, a set of IT events are correlated according to the correlation factor to form an IT transaction. Specifically, events without the father correlation factor are found, and then a set of IT events is correlated according to the delivery relationship of correlation factors (that is, the father correlation factor of the current event is equal to the current correlation factor of the last event). Once a set of IT events is correlated to form an IT transaction, BPID and TASK ID occurring in IT events currently related to the IT transaction are extracted as a feature value of the current IT transaction.

Once all IT transactions are formed, they are correlated according to the correlation rules to form a business transaction. For example, if IT transactions have equal BPID or TASK ID, then they are correlated to form a business transaction.

Once a business transaction is determined, all IT events are extracted according to the relationships between the business transaction and IT transactions and between IT transactions and IT events, to form a calling sequence as the business transaction pattern of this business transaction.

As shown in FIG. 4, how to generate a business transaction pattern will be illustrated in the context of an example of travel route reservation. In this example, a customer first sends a request 412 for travel route booking. At this point, a travel route booking flow 422 is initiated. Next, a credit card company creates a task 414 of credit card checking, which task is fulfilled by a staff member. Then, a car reservation component 432 is called to reserve a car, and an airline reservation component 434 is called to reserve tickets, and a hotel reservation flow 424 is called to reserve a hotel. Hotel reservation flow 424 subsequently calls a hotel information center 436 component to acquire available hotels and generates a task 418 of selecting a hotel. Once the user completes the task of selecting a hotel, hotel reservation flow 424 will call a corresponding hotel component (such as one of hotel 1 component 442, hotel 2 component 444 and hotel n component 446) to reserve a room. Finally, the customer is informed of a reservation result 416.

During the entire process of travel route booking as shown in FIG. 4, the system will generate IT events as shown in Table 1.

TABLE 1

| | | Father | Current | |
|---|---|---|---|---|
| | | correlation | correlation | |
| ID | Description | Factor ID | Factor ID | Feature value |
| 1 | Initiate a travel | Null | 1 | travelBookingBPID, |
| | route booking | | | |
| | flow | | | |
| 2 | Create the task | 1 | 2 | creditcardTaskID, |
| | of credit card | | | |
| | checking | | | |
| 3 | Complete the | Null | 3 | creditcardTaskID, |
| | task of the | | | |
| | credit card | | | |
| | checking | | | |
| 4 | Call a car | 3 | 4 | |
| | reservation | | | |
| | component | | | |
| 5 | Call an airline | 3 | 5 | |
| | reservation | | | |
| | component | | | |
| 6 | Initiate a hotel | 3 | 6 | hotelReservationBPID |
| | reservation flow | | | |
| 7 | Call a hotel | 6 | 7 | |
| | information | | | |
| | center | | | |
| | component | | | |
| 8 | Create the task | 6 | 8 | selectHotelTaskID |
| | of selecting a | | | |
| | hotel | | | |
| 9 | Complete the | Null | 9 | selectHotelTaskID |
| | task of selecting | | | |
| | a hotel | | | |
| 10 | Call a hotel | 9 | 10 | |
| | component | | | |

According to the correspondences shown in Table 1, 1 and 2 are correlated to form IT transaction 1 which has the feature values of creditcardTaskID and travelBookingBPID; 3, 4, 5, 6, 7, and 8 are correlated to form IT transaction 2 which has the feature values of creditcardTaskID, hotelReservationBPID and selectHotelTaskID; and 9 and 10 are correlated to form IT transaction 3 which has a feature value of selectHotelTaskID. Now, three IT transactions as shown in Table 2 are acquired.

TABLE 2

| IT transaction ID | Feature value |
|---|---|
| IT transaction 1 | creditcardTaskID, travelBookingBPID |
| IT transaction 2 | creditcardTaskID, |
| | hotelReservationBPID, and |
| | selectHotelTaskID |
| IT transaction 3 | selectHotelTaskID |

Assume the current correlation rules are as follows:

Rule 1: if feature values BPID or TASK ID of all IT transactions contained in one business transaction are the same as BPID or TASK ID contained in a certain IT transaction to be correlated, then this IT transaction to be correlated is correlated with this business transaction;

Rule 2: if a certain IT transaction cannot be correlated with an existing business transaction, then a new business transaction is generated and correlated with this IT transaction.

At the beginning, since there is no business transaction in the current system, a new business transaction 1 will be generated and correlated with IT transaction 1. At this point, business transaction 1 contains IT transaction 1. Since IT transaction 1 and IT transaction 2 contains the same TASK ID, i.e. creditcardTaskID, IT transaction 2 is correlated with business transaction 1. At this point, business transaction 1 contains IT transaction 1 and IT transaction 2. Since IT transaction 2 and IT transaction 3 contain the same TASK ID, i.e. selectHotelTaskID, IT transaction 3 is correlated with business transaction 1. Since there is no other IT transaction that can be correlated, the generation of business transaction 1 is completed.

Business transaction 1 is IT transaction 1→IT transaction 2→IT transaction 3.

Corresponding IT events in each IT transaction are extracted together to form the business transaction pattern corresponding to business transaction 1:

Initiate the travel route booking flow→create the task of credit card checking→complete the task of credit card checking→call a car reservation component→call an airline reservation component→initiate a hotel reservation flow→call a hotel information center component→create the task of selecting a hotel→complete the task of selecting a hotel→call a hotel component.

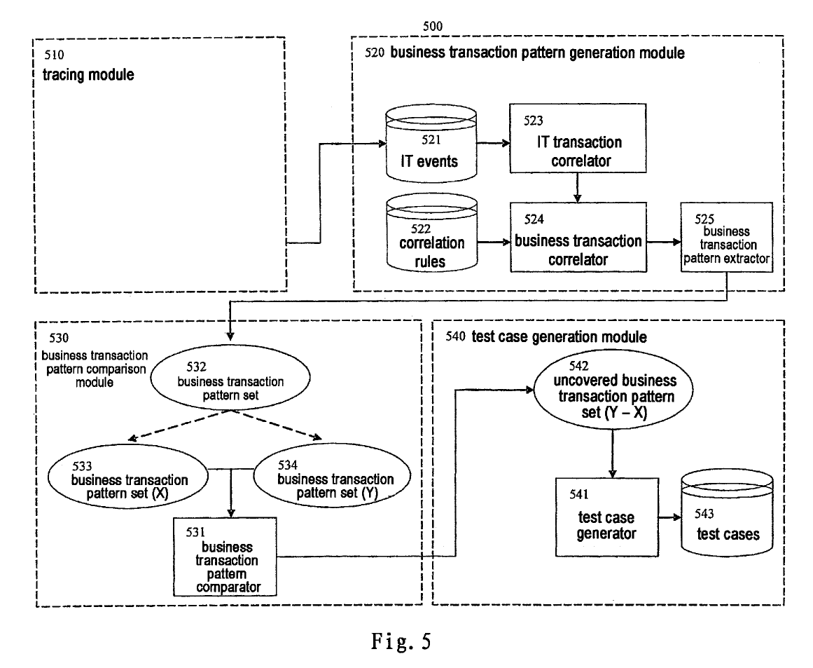

Referring to FIG. 5, a detailed description will be given below to an apparatus for generating business level test cases according to an embodiment of the present invention. FIG. 5 illustrates a high-level block diagram of an apparatus 500 for generating business level test cases according to an embodiment of the present invention.

Apparatus 500 comprises the following four modules: a tracing module 510, a business transaction pattern generation module 520, a business transaction pattern comparison module 530, and a test case generation module 540.

Tracing module 510 may trace each user request to generate IT events 521 related to each service/component invocation, wherein the event records the invoked service, operation, parameter value and correlation information which helps to correlate all related service call events with a request. Afterwards, tracing module 510 transfers acquired IT events 521 to business transaction pattern generation module 520.

Business transaction pattern generation module 520 may analyze IT events 521 received from tracing module 510, correlate received IT events 521 and acquire from them a business transaction pattern with actual business meaning.

Business transaction pattern generation module 520 may comprise an IT transaction correlator 523, business transaction correlator 524, a business transaction pattern extractor 525, and further correlation rules 522 for correlating IT transactions. Correlation rules 522 define, in a logic expression way, which set of IT transactions is correlated according to the values of parameters for service invocation and context information. For example, if two IT transactions serve the same identical business process instance, then they are correlated through, for example, TASK ID and BPID (Business Process Instance ID).

First, IT transaction correlator 523 organizes IT events 521 received from tracing module 510, in order to form IT transactions according to the correlation information in IT events 521 and by means of the method shown in FIGS. 2 and 3.

Then, according to the predetermined correlation rules 522, business transaction correlator 524 correlates a set of IT transactions, by means of the method shown in FIGS. 2 and 3, to form a business transaction, and it transfers the formed business transaction to business transaction pattern extractor 525 as outputs.

During the business transaction pattern building, business transaction pattern extractor 525 extracts business transaction patterns from the business transaction. For example, it extracts all IT events which the business transaction involves as its business transaction pattern. Business transaction pattern extractor 525 sends the extracted business transaction patterns to business transaction pattern comparison module 530 as outputs of the entire business transaction pattern generation module 520.

As shown in FIG. 5, business transaction comparison module 530 may comprise a business transaction pattern comparator 531 and further comprise a business transaction pattern set 532. Business transaction pattern set 532 may involve two portions: a business transaction pattern set (X) 533 which contains a business transaction pattern set (represented by “X”) generated based on the test environment; and a business transaction pattern set (Y) 534 which contains a business transaction pattern set (represented by “Y”) generated based on the production environment.

Business transaction pattern comparator 531 may compare test environment-based business transaction pattern set (X) 533 with production environment-based business transaction pattern set (Y) 534 to find the difference between them. Then, business transaction pattern comparator 531 transfers the comparison results to test case generation module 540.

Test case generation module 540 may comprise a test case generator 541 which receives from business transaction comparison module 530 the comparison results from business transaction pattern comparator 531, i.e. an uncovered business transaction pattern set (Y−X) 542, and which generates test cases 543 for each business transaction pattern in the set.

Finally, generated test cases 543 are supplemented to the test cases set used in the current round of iteration, and the new test cases set will be used for the next round of iteration.

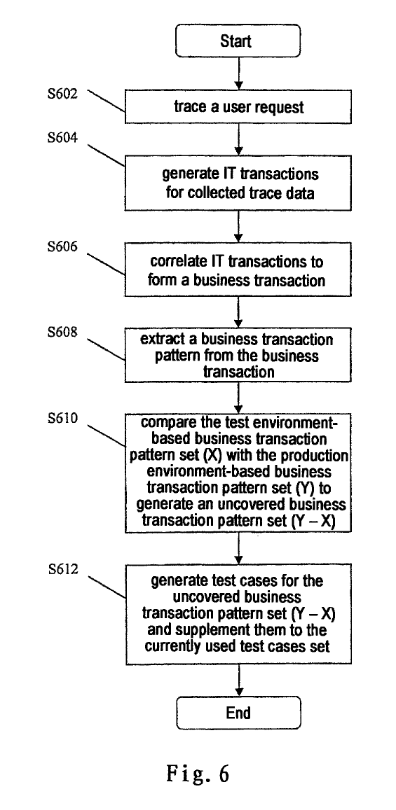

FIG. 6 illustrates a flowchart of a method for generating business level test cases according to an embodiment of the present invention.

First, in step S602, tracing module 510 traces a user request and sends acquired IT events 521 to business transaction pattern generation module 520.

Then, in step S604, IT transaction correlator 523 in business transaction pattern generation module 520 correlates received IT events 521 to form IT transactions.

Next, in step S606, business transaction correlator 524 correlates, according to the predetermined correlation rules, input IT transactions to form a business transaction and then sends the business transaction to business transaction pattern extractor 525.

In step S608, business transaction pattern extractor 525 extracts business transaction patterns from the business traction. For example, it extracts all IT events which the business transaction involves as its business transaction pattern. After that, business transaction pattern extractor 525 inputs the extracted business transaction patterns to business transaction pattern comparison module 530.

In step S610, business transaction pattern comparator 531 compares test environment-based business transaction pattern set (X) 533 with production environment-based business transaction pattern set (Y) 534 to find the difference between them, and it transfers results from business transaction pattern comparator 531 to test case generation module 540.

In step S612, test case generation module 540 receives from business transaction comparison module 530 the comparison results from business transaction pattern comparator 531, generates test cases 543 for uncovered business transaction pattern set (Y−X) 542, and supplements them to the currently used test cases set.

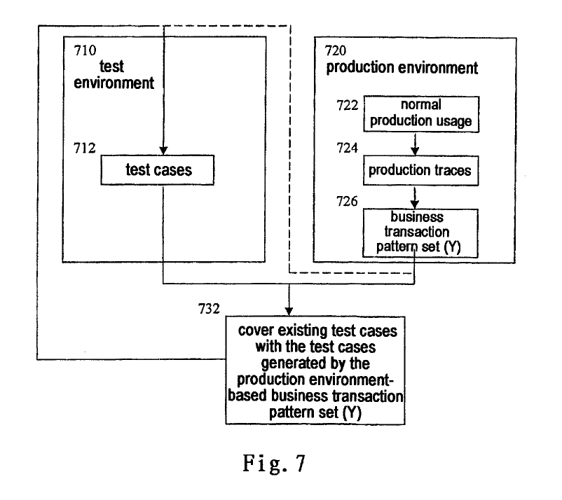

FIG. 7 illustrates a high-level conceptual view of a method for generating business level test cases according to another embodiment of the present invention.

Another embodiment according to the present invention is similar to the embodiment according to FIG. 1. The difference between them istracing the production stage so as to generate test cases directly and then to replace the existing test cases with the generated test cases without tracing the testing stage.

Specifically, as shown in FIG. 7, a test environment 710 is a test environment in which testers test a software system, and a production environment 720 is an environment in which users actually use the software system.

Before the start of the first round of testing, testers first generate test cases used for the first round of testing by a traditional method. In production environment 720, a production environment-based business transaction pattern set 726, which is represented here by symbol “Y,” is formed through normal production usage 722 and production traces 724 of a software system under testing.

Then, in a block 732, existing test cases are covered by test cases generated by business transaction patterns in production environment-based business transaction pattern set (Y) 726 for the current round of regression testing, and then the next round of regression testing is executed.

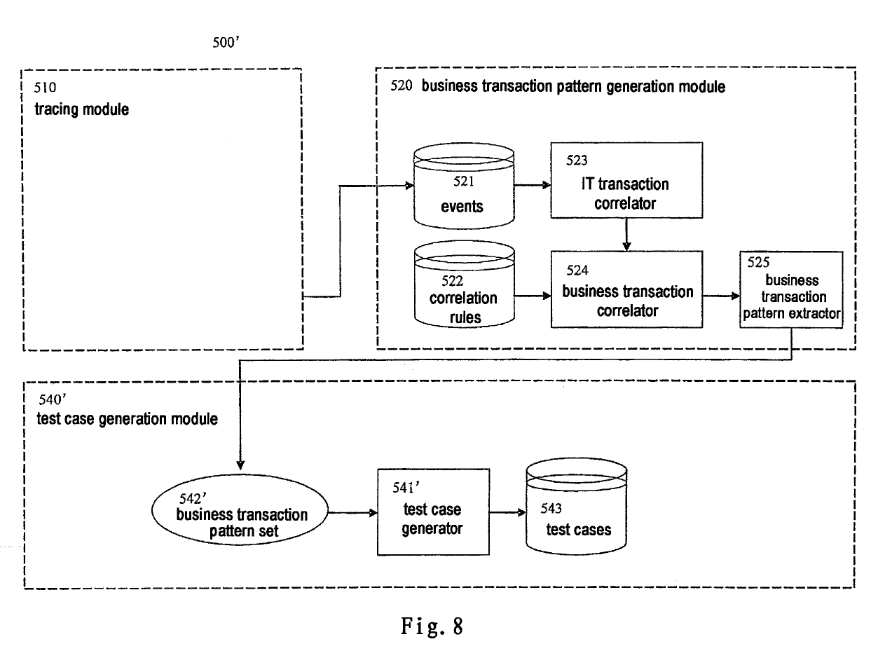

FIG. 8 illustrates a high-level block diagram of an apparatus 500′ for generating business level test cases according to another embodiment of the present invention.

Apparatus 500′ in FIG. 8 differs from apparatus 500 in FIG. 5 in replacing business transaction pattern comparison module 530 and test case generation module 540 in FIG. 5 with test case generation module 540′. Other parts are similar to those in FIG. 5, and detail descriptions thereof are thus omitted here.

As shown in FIG. 8, test case generation module 540′ may comprise a test case generator 541′ which receives from business transaction generation module 520 production environment-based business transaction patterns 542′, covers existing test cases with test cases 543 generated by the production environment-based business transaction patterns, and then implements the next round of regression testing.

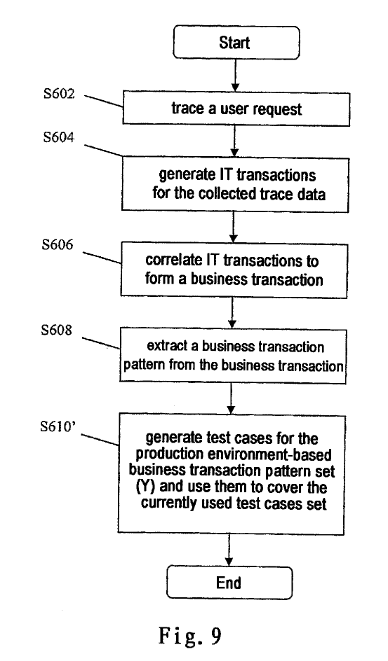

FIG. 9 illustrates a flowchart of a method for generating business level test cases according to another embodiment of the present invention.

The method in FIG. 9 differs from the method in FIG. 6 in replacing steps S610 and S612 with step S610′. Other steps are similar to those in FIG. 6, and detailed descriptions thereof are thus omitted here.

Specifically, in step S610′, test case generation module 540′ receives from business transaction generation module 520 production environment-based business transaction patterns 542′, covers existing test cases with test cases 543 generated by the production environment-based business transaction patterns, and then executes the next round of regression testing.

The present invention has many advantages over the prior art. First of all, the present invention achieves SOA architecture level gray-box testing coverage by discovering uncovered real usage scenarios based on runtime trace. This improves the productivity of testers in designing business level test cases. These productivities can be translated into cost savings and reduced project durations. In the second place, the present invention does not need a specific tracing mechanism. A general tracer which can capture the service/component invocation is enough, and there is no need to construct a different tracer for a different application under testing.

The present invention may be implemented as hardware, software, firmware and a combination thereof. Those skilled in the art should recognize that the present invention may also be implemented in a computer program product arranged on a signal carrier medium to be used for any proper data processing system. Such signal carrier medium may be a transmission medium or a recordable medium used for machine readable information, including a magnetic medium, optical medium or other proper medium. Examples of a recordable medium include a floppy or hard disc in a hard disc drive, an optical disc for an optical drive, a magnetic tape and other medium those skilled in the art can conceive. Those skilled in the art should further recognize that any communication terminal with proper programming means can implement the steps of the method of the present invention embodied in a program product.

It is to be understood from the foregoing description that modifications and alterations may be made to all embodiments of the present invention without departing from the spirit of the present invention. The description in the present specification is intended to be illustrative and not limiting. The scope of the present invention is limited by the claims only.

What is claimed is:

1. A method of generating a business transaction pattern of a software system, comprising the steps of:
tracing a user request to acquire IT events related to a service and/or component invocation;
forming IT transactions based on correlation information in said IT events;
correlating said IT transactions based on predetermined correlation rules in order to form a business transaction; and
extracting from said business transaction said business transaction pattern.

2. The method according to claim 1, wherein said predetermined correlation rules specify that a set of IT transactions are correlated according to values of parameters for service and/or component invocations in said IT events contained in said IT transactions and context information.

3. The method according to claim 1, wherein said steps are performed in (i) a test environment using a currently used test cases set and (ii) a production environment using a normal production to generate a test environment-based and a production environment-based business transaction pattern sets, respectively.

4. The method according to claim 3, further comprising the steps of:
comparing said test environment-based business transaction pattern set and said production environment-based business transaction pattern set to acquire an uncovered business transaction pattern set;
generating new test cases of a software system based on each business transaction pattern in said uncovered business transaction pattern set; and
adding said new test cases to said currently used test cases set.

5. The method according to claim 4, wherein said software system is a Service-Oriented Architecture.

6. The method according to claim 1, wherein said steps are performed in a production environment to generate a production environment-based business transaction pattern set.

7. The method according to claim 6, further comprising the steps of:
generating new test cases of a software system based on each business transaction pattern in said production environment-based business transaction pattern set; and
adding said new test cases to a currently used test cases set.

8. The method according to claim 7, wherein said software system is a Service-Oriented Architecture.

9. An apparatus for generating business transaction patterns of a software system, comprising:
means for tracing a user request to acquire IT events related to a service and/or component invocation;
means for forming IT transactions based on correlation information in said IT events;
means for correlating said IT transactions based on predetermined correlation rules in order to form a business transaction; and
means for extracting from said business transaction a business transaction pattern.

10. The apparatus according to claim 9, wherein said predetermined correlation rules specify that a set of IT transactions are correlated according to values of parameters for service and/or component invocations in said IT events contained in said IT transactions and context information.

11. The apparatus according to claim 9, wherein said means are located in (i) a test environment using a currently used test cases set and (ii) a production environment using a normal production to generate a test environment-based and a production environment-based business transaction pattern sets, respectively.

12. The apparatus according to claim 11, further comprising:
means for comparing said test environment-based business transaction pattern set and said production environment-based business transaction pattern set to acquire an uncovered business transaction pattern set;
means for generating new test cases of a software system based on each business transaction pattern in said uncovered business transaction pattern set; and
means for adding said new test cases to said currently used test cases set.

13. The apparatus according to claim 12, wherein said software system is a Service-Oriented Architecture.

14. The apparatus according to claim 9, wherein said means are located in a production environment that generates a production environment-based business transaction pattern set.

15. The apparatus according to claim 14, further comprising:
means for generating new test cases of a software system based on each business transaction pattern in said production environment-based business transaction pattern set; and
means for adding said new test cases to a currently used test cases set.

16. The apparatus according to claim 15, wherein said software system is a Service-Oriented Architecture.
